(19) United States
(12) Patent Application Publication
(10) Pub. No.: US 2026/0063102 A1
(43) Pub. Date: Mar. 5, 2026

(54) WIND TURBINE BLADE, WIND TURBINE AND METHOD FOR OPERATING A WIND TURBINE

(71) Applicants: LM Wind Power A/S, Kolding (DK); General Electric Renovables Espana, S.L., Barcelona (ES)

(72) Inventors: Jacob Johannes Nies, Breda (NL); Connor Brooks Shane, Schenectady, NY (US)

(21) Appl. No.: 19/100,987

(22) PCT Filed: Jul. 28, 2023
(86) PCT No.: PCT/EP2023/071049

§ 371 Date: Feb. 4, 2025

(30) Foreign Application Priority Data
Aug. 4, 2022 (EP) 22188817.5

(51) Int. Cl. F03D 1/06; F03D 7/02

(52) U.S. Cl. CPC F03D 1/0679; F03D 1/0685; F03D 7/0296

(57) ABSTRACT

A wind turbine blade (10, 10′) includes a shell (11) and a torque transferring member (20) at least partly arranged inside the shell (11). The shell (11) includes a root portion (12) and defines a longitudinal direction (r₁₁). The torque transferring member (20) includes a root section (21) and a longitudinal axis (r₂₀) at least substantially parallel oriented to the longitudinal direction (r₁₁). The root section (21) of the torque transferring member (20) is rotatably around the longitudinal axis (r₂₀) with respect to the root portion (12) of the shell (11). The torque transferring member (20) is mechanically connected via a coupling (26) with the shell (11) for providing a torsional moment (ΔT₁-ΔT₃) on the shell (11).

### FIELD

The present subject matter relates generally to a wind turbine blade, in particular a torsionally loadable wind turbine blade, a wind turbine with one or more wind turbine blades, and a related method for operating the wind turbine.

### BACKGROUND

Wind power is considered one of the cleanest, most environmentally friendly energy sources presently available, and wind turbines have gained increased attention in this regard. A modern wind turbine typically includes a tower, generator, gearbox, nacelle, and a rotor with one or more rotor blades. The rotor blades capture kinetic energy from wind using known foil principles and transmit the kinetic energy through rotational energy to turn a shaft coupling the rotor blades to a gearbox, or if a gearbox is not used, directly to the generator. The generator then converts the mechanical energy to electrical energy that may be deployed to a utility grid.

Rotor blade torsion is typically causing non-optimal angle of attack over the range of operating wind speeds. Since the speed of the rotor blades relative to the wind increases towards the rotor blade tips, the shape of the rotor blades is typically twisted in order to maintain a generally consistent angle of attack at most points along the span of the blade.

However, fixed twist angles may be optimized for only one set of operating parameters for the wind turbine. Further, the possibilities known so far to influence the torsion of the rotor blades during operation are not flexible enough, too complicated, too maintenance-intensive and/or too expensive.

Accordingly, the present disclosure provides a wind turbine blade according to claim 1, a method for operating a wind turbine according to claim 7, and a wind turbine according to claim 11.

### BRIEF DESCRIPTION

Aspects and advantages of the invention will be set forth in part in the following description, or may be obvious from the description, or may be learned through practice of the invention.

In one aspect, the present disclosure is directed to a wind turbine blade including a shell and a torque transferring member at least partly arranged inside the shell. The shell includes a root portion and defines a longitudinal direction. The torque transferring member includes a root section and a longitudinal axis at least substantially parallel oriented to the longitudinal direction. The root section of the torque transferring member is rotatably around the longitudinal axis with respect to the root portion of the shell. The torque transferring member is mechanically connected via a coupling with the shell for providing a torsional moment on the shell.

Accordingly, a torsional moment may be provided on the shell as a function of an angle of rotation of the root section of the torque transferring member around the longitudinal axis and/or a coupling status between the torque transferring member and the coupling.

This allows for influencing the torsion of the rotor blades during operating the wind turbine in a comparatively simple, low maintenance and flexible way, and at comparatively low extra cost. Moreover the extra cost are typically by far overcompensated by the gain in the annual energy production (AEP) that can be achieved due to optimizing the angle of attack of the wind turbine blade(s) over a large range of operating conditions and wind speeds.

For example, for a 1.5 MW wind turbine under typical average conditions, the value of the AEP-increase may be at least about two times the additional costs for equipping the wind turbine accordingly.

Furthermore, loads acting on the wind turbine and, thus, maintenance effort and/or costs may be reduced.

In particular, the load on pitch bearings may be reduced by trading between pitch activity by rolling bearings to flexing the structure.

Further, the susceptibility of the wind turbine blade(s) to gusts at high wind speeds may be reduced by appropriately twisting back the wind turbine blade(s).

Even further, leading edge erosion during rain and hail may be reduced by adjusting the angle of attack for those conditions as optimal as possible or at least close thereto.

As a result, the extra costs can be amortized quickly.

Furthermore, safety of the wind turbine may be improved.

In particular, partially or completely shutting down of the wind turbine may be facilitated, for example in response to a fault in a grid the wind turbine is connected to for delivering electric power, by combined pitching and changing the twisting status of the wind turbine blade(s).

Even further, noise produced by the wind turbine may be reduced by applying suitable torsional moments to appropriately change the twisting status of the wind turbine blade(s) during operation.

Note that noise reduction may be particularly important to reduce possible impacts on the environment and increase acceptance of wind turbines, respectively.

Furthermore, torsional stiffness of the rotor blade may be tuned during the lifetime of the rotor blade.

The term “torsional moment” as used herein intends to embrace the term “twisting moment”.

The wording that the longitudinal axis of the torque transferring member is at least substantially parallel oriented to the longitudinal direction of the (blade) shell intends to describe that an angular deviation is below a few degrees, in particular below 2° or even 1° if the angular deviation is determined for the root section and the root portion, and/or if the rotor blade is not exposed to wind at speeds causing bending of the shell.

The root section of the torque transferring member is typically at least partially arranged within the root portion of the shell and/or at least substantially coaxial with respect to the root portion of the shell.

However, the root section of the torque transferring member may also be arranged in a middle section of the wind turbine blade and between the root portion of the shell and a tip portion of the shell, respectively, or even (partially or completely) outside the blade root, e.g. in a hub of the wind turbines rotor.

The term “torque transferring member” as used herein intends to describe a typically substantially mechanically stiff, elongated mechanical element or body for transferring a torque (to one or more couplings) that depends on a twisting of the torque transferring member with respect to its longitudinal axis (angle of rotation of the root section with respect to a tip section and the rotor blade, respectively). The transferred torque may be large enough to change a twisting state of the shell of the rotor blade substantially, i.e. up to at least one, more typically up to at least 5° or even up to at least 10° when measured from root (portion) to tip (portion).

Typically, the torque transferring member has a cylindrical outer surface.

The torque transferring member may in particular include a cylindrical shell and/or be implemented as a tube such as a tube with circular cross-section.

Further, the torque transferring member may include or even be made of a fiber-reinforced plastic.

The torque transferring member is typically mechanically connected via several couplings with the shell at distinct locations which are spaced apart from each other in the longitudinal direction.

This allows greater freedom and/or flexibility in applying the torsional moment on the shell as function of span and longitudinal coordinate with respect to the longitudinal direction (which is in the following also referred span direction) and/or depending on an operational condition of the wind turbine.

In other words, the torque transferring member may be mechanically connected via at least one coupling with the shell for providing a respective torsional moment on the shell.

The coupling and/or the coupling status may even be controllable.

The coupling status may include a no engagement status, and/or a full engagement status.

Further, the coupling status may include a partial engagement status.

Furthermore, a stiffness of the coupling may depend on the provided torsional moment.

Even further, the mechanical properties of at least two of the couplings may be different.

Further, the mechanical properties of the respective coupling may depend on a sign of the angle of rotation and/or a magnitude of the angle of rotation.

Furthermore, the respective coupling may have, in particular with respect to a movement of a respective connected portion of the torque transferring member around the longitudinal axis, at least one of:
a clearance;
a linear stiffness;
a progressive stiffness; and
a degressive stiffness.

According to an embodiment, the rotor blade may include a (at least one) torque meter for measuring a torque value typically depending on the provided torsional moment, in particular a torque meter for measuring a torque value representing a (total) torque acting at the torque transferring member.

This may facilitate controlling the twisting status of the wind turbine blade.

For example, the (at least one) torque meter may be attached to and/or provided by the coupling.

The torque meter may even be provided by an actuator connected with the root section. For example, a current of an electric motor used for rotating the root section of the torque transferring member around the longitudinal axis may be used as measure of the total torsional moment.

The current of the electric motor may even be (pre-)determined (measured) as a function of the angle of rotation of the root section. This curve may later be used for controlling during normal operation and/or to detect the neutral angle at any rotor position and point of operation, respectively.

Furthermore, the respective coupling may be arranged between a load bearing structure of the wind turbine blade and the torque transferring member.

The load bearing structure may include a spar of the rotor blade, typically as the main load bearing structure of the rotor blade.

The load bearing structure may however also include several substructures.

Further, even the shell which typically defines the airfoil of the rotor blade may be considered as part of the load bearing structure.

In one aspect, the present disclosure is directed to a wind turbine including a wind turbine blade as explained herein, for example three respective wind turbine blades.

The wind turbine typically includes an actuator such as an electric motor for moving the torque transferring member with respect to the shell of the rotor blade.

In particular, the actuator may include and/or be provided by the (electric) motor, or the motor and a brake.

The brake may in particular be configured/used for (at least substantially) fixing the root section of the torque transferring member in a respective desired arrangement with respect to the root portion of the shell (position and/or orientation), in particular at a respective desired angle of rotation of the root section of the torque transferring member with respect to the longitudinal axis. Accordingly, the motor may only be activated if the desired arrangement changes.

More typically, the wind turbine typically includes a respective actuator for each of its rotor blades.

For this purpose, the actuator is connected with the root section, typically via a gearbox, and configured to rotate the root section of the torque transferring member around the longitudinal axis.

The gearbox may include or even be provided by a worm gear.

Alternatively or in addition, the actuator may be configured to translatory move the root section in the longitudinal direction with respect to the shell of the rotor blade.

By translatory moving the root section and, thus, the whole torque transferring member in the longitudinal direction with respect to the shell, the coupling state coupling(s) may be changed.

Furthermore, the actuator may be configured to measure a total torque and to provide a measure for the total torque, respectively, such a motor current.

The actuator(s) is (are) typically connected with a controller of the wind turbine which is configured to control the actuator.

The controller of the wind turbine may be configured to use the measured torque (representing value) for controlling the actuator, in particular such that the twisting state of the rotor blade is influenced/changes into a desired state for the given operating condition(s) of the wind turbine.

The controller of the wind turbine may be provided by the wind turbine controller, by a separate controller, by a pitch controller of the respective rotor blade (integrated into the pitch controller) or any combination thereof.

In other words, the controller may be provided by a control system for or of the wind turbine that may include one or more controllers.

Typically, the controller(s) of the wind turbine is (are) configured to operate the wind turbine in accordance with any of the methods explained herein.

In one aspect, the present disclosure is directed to a method for operating a wind turbine. The wind turbine incudes a rotor including a rotor blade having a shell defining a longitudinal direction, and a torque member mechanically connected via a coupling with the shell for providing a torsional moment on the shell, in particular a rotor blade as explained herein, and an actuator mechanically connected with the torque member. The method includes determining, during (normally) operating the wind turbine, a current torsional state of the shell, determining a desired torsional state of the shell, and using at least one of the actuator and the coupling to change the torsional moment on the shell so that a difference between the current torsional state of the shell and the desired torsional state of the shell is expected to be at least reduced.

The current torsional state and the desired torsional state of the shell are typically determined based on one or more current operating parameters of the wind turbine, in particular a current wind condition.

Determining the current torsional state of the shell may include a measurement, a calculation, a simulation and/or using a look-up table, in particular a look-up table with predetermined values allowing for determining desired angles of rotation of the root section of the torque transferring member to achieve a respective desired torsional state of the shell for given current operating parameter(s) of the wind turbine and/or optimizing criteria.

The desired torsional state of the shell may be determined and the torsional moment on the shell changed, respectively, as a function of a rotor position, a wind speed, a horizontal misalignment between a rotor axis of the rotor and a wind direction such as an upflow, a yaw misalignment, a shear of the wind and a veer.

The torsional state of the shell may be changed to counteract an instability of the wind turbine blade such as a whirling instability, in particular low frequency whirling instability (e.g. at about 0.5 Hz), to adjust a distribution of an angle of attack over the length of the wind turbine blade, to aid in pitching the wind turbine blade, to reduce noise, and/or to align the aerodynamic and/or mechanic properties of the wind turbine blade with another wind turbine blade of the wind turbine.

Note that (actively) counteracting (whirling) instabilities of the wind turbine blade may substantially reduce load and wear, respectively. Accordingly, maintenance may be reduced and/or lifetime of components increased.

The method may include one or more of the following processes:
determining the current torsional state of the shell as function of the longitudinal coordinate;
selecting, for the rotor blade, a parameter, in particular an angle of attack;
determining a current functional dependency of the selected parameter in the longitudinal direction; and
selecting an optimizing criterion.

Selecting the optimizing criterion typically depends on a current (actual) operating parameter of the wind turbine and/or a current wind condition, in particular a wind speed.

The optimizing criterion may depend on and/or be selected from a noise, a load, a power production, a stability, and any combination thereof.;

For example, optimizing may e.g. be performed at low wind speed with respect to noise and power production, at medium wind speed with respect to noise and loads, and/or at high wind speed with respect to noise and stability.

Furthermore, the method may include one or more of the following processes:
determining, in accordance with the selected optimizing criterion, a desired functional dependency of the selected at least one parameter in the longitudinal direction;
determining a deviation between the current functional dependency and the desired functional dependency of the selected at least one parameter in the longitudinal direction;
determining a desired twist of the shell; and
determining a desired torsional moment to be exerted on the shell in order to at least reduce the deviation.

Thereafter, the torque transferring member and the coupling(s) may be used to exert the desired torsional moment on the shell.

The method may be repeated several times, for example in a cyclic manner.

In yet another aspect, the present disclosure is directed to a computer program product or a non-transitory computer-readable storage medium comprising instructions which, when executed by one or more processors of a system, in particular a controller or control system of the wind turbine as explained herein, cause the system to carry out the method as explained herein.

As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. The processor may also be configured to compute advanced control algorithms and communicate to a variety of Ethernet or serial-based protocols (Modbus, OPC, CAN, etc.). Additionally, the processor may have access to memory device(s) that may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magnetooptical disk (MOD), a digital versatile disc (DVD) and/or other suitable memory elements. Such memory device(s) may generally be configured to store suitable computer-readable instructions that, when implemented by the processor(s), configure the controller to perform the various functions as described herein.

These and other features, aspects and advantages of the present invention will be further supported and described with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of a wind turbine according to an embodiment of the present disclosure;

FIG. 2A illustrates a schematic side view of an embodiment of a wind turbine rotor blade according to the present disclosure;

FIG. 2B illustrates a schematic cross-sectional view of an embodiment of a wind turbine rotor blade according to the present disclosure;

FIG. 2C illustrates a schematic side view of an embodiment of a wind turbine rotor blade and a wind turbine according to the present disclosure, and plots of torque versus span for the wind turbine rotor blade;

FIG. 3A illustrates a flow chart of a method according to an embodiment of the present disclosure; and

FIG. 3B illustrates a flow chart of a method according to an embodiment of the present disclosure.

Single features depicted in the figures are shown relatively with regards to each other and therefore are not necessarily to scale. Similar or same elements in the figures, even if displayed in different embodiments, are represented with the same reference numbers

### DETAILED DESCRIPTION OF THE INVENTION

Reference now will be made in detail to embodiments of the invention, one or more examples of which are illustrated in the drawings. Each example is provided by way of explanation of the invention, which shall not limit the invention. In fact, it will be apparent to those skilled in the art that various modifications and variations can be made in the present invention without departing from the scope or spirit of the invention, for instance, features illustrated or described as part of one embodiment can be used with another embodiment to yield a still further embodiment. Thus, it is intended that the present invention covers such modifications and variations as come within the scope of the appended claims and their equivalents.

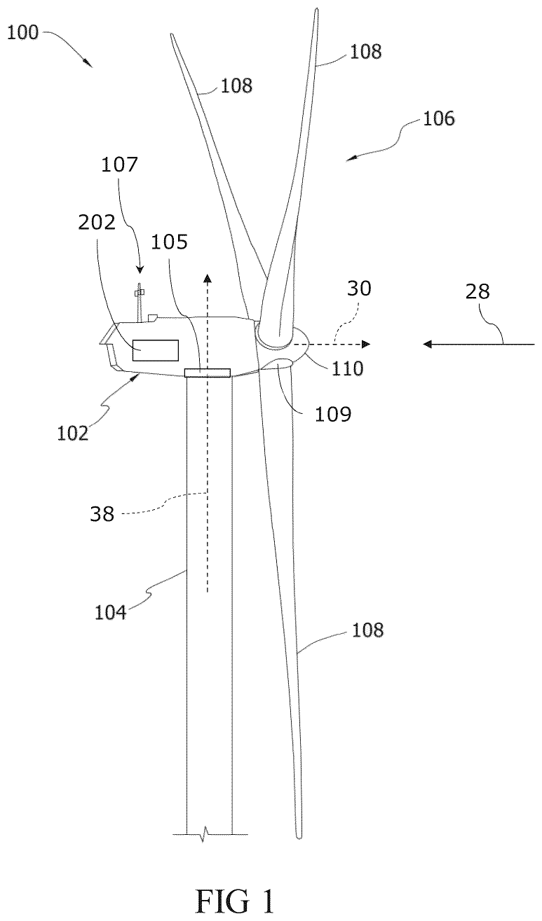

FIG. 1 is a perspective view of a portion of an exemplary wind turbine 100. In the exemplary embodiment, the wind turbine 100 is a horizontal-axis wind turbine. Alternatively, the wind turbine 100 may be a vertical-axis wind turbine. Wind turbine 100 includes a nacelle 102 housing a generator (not shown in FIG. 1). Nacelle 102 is mounted on a tower 104 (a portion of tower 104 being shown in FIG. 1). Tower 104 may have any suitable height that facilitates operation of wind turbine 100 as described herein. Wind turbine 100 also includes a rotor 106 that includes three wind turbine blades 108 attached to a rotating hub 110. In the following, the wind turbine blades are also referred to as wind turbine rotor blades, and rotor blades for short. Alternatively, wind turbine 100 includes any number of blades 108 that facilitates operation of wind turbine 100 as described herein. In the exemplary embodiment, wind turbine 100 includes a gearbox (not shown in FIG. 1) operatively coupled to rotor 106 and a generator (not shown in FIG. 1).

The rotor blades 108 are spaced about the hub 110 to facilitate rotating the rotor 106 to enable kinetic energy to be transferred from the wind into usable mechanical energy, and subsequently, electrical energy.

According to an embodiment, each rotor blade 108 includes a respective torque transferring member which is mechanically connected via a coupling with the outer shell for providing a torsional moment on the shell if desired.

In one embodiment, the rotor blades 108 have a length ranging from about 15 meters (m) to about 91 m. Alternatively, rotor blades 108 may have any suitable length that enables the wind turbine 100 to function as described herein. For example, other non-limiting examples of blade lengths include 20 m or less, 37 m, 48.7 m, 50.2 m, 52.2 m or a length that is greater than 91 m. As wind strikes the rotor blades 100 from a wind direction 28, the rotor 106 is rotated about an axis of rotation 30. As the rotor blades 108 are rotated and subjected to centrifugal forces, the rotor blades 108 are also subjected to various forces and moments. As such, the rotor blades 108 may deflect and/or rotate from a neutral, or non-deflected, position to a deflected position.

Moreover, a pitch angle of the rotor blades 108, i.e., an angle that determines a perspective of the rotor blades 108 with respect to the wind direction, may be changed by a pitch system 109 to control the load and power generated by the wind turbine 100 by adjusting an angular position of at least one rotor blade 108 relative to wind vectors. During operation of the wind turbine 100, the pitch system 109 may change a pitch angle of the rotor blades 108 such that the rotor blades 108 are moved to a feathered position, such that the perspective of at least one rotor blade 108 relative to wind vectors provides a minimal surface area of the rotor blade 108 to be oriented towards the wind vectors, which facilitates reducing a rotational speed and/or facilitates a stall of the rotor 106.

A blade pitch of each rotor blade 108 may be controlled individually by a wind turbine controller 202 or by a pitch control system. Alternatively, the blade pitch for all rotor blades 108 may be controlled simultaneously by said control systems.

Further, in the exemplary embodiment, as the wind direction 28 changes, a yaw direction of the nacelle 102 may be rotated, by a yaw system 105, about a yaw axis 38 to position the rotor 106 with respect to wind direction 28.

The yaw system 105 may include a yaw drive mechanism provided by nacelle 102.

Further, yaw system 105 may also be controlled by wind turbine controller 202.

For positioning nacelle 102 appropriately with respect to the wind direction 28 as well as detecting a wind speed, the nacelle 102 may also include at least one meteorological mast 107 that may include a wind vane and anemometer. The mast 107 may provide information to the wind turbine controller 202 regarding ambient conditions. This may include wind direction and/or wind speed as well as ambient temperature, ambient moisture, precipitation type and/or amount (if any).

In the exemplary embodiment, the wind turbine controller 202 is shown as being centralized within the nacelle 102, however, the wind turbine controller may also be a distributed system throughout the wind turbine 100, on a support system (not shown in FIG. 1), within a wind farm, and/or at a remote-control center. The wind turbine controller 202 includes a processor and may be configured to perform the methods and/or steps described herein.

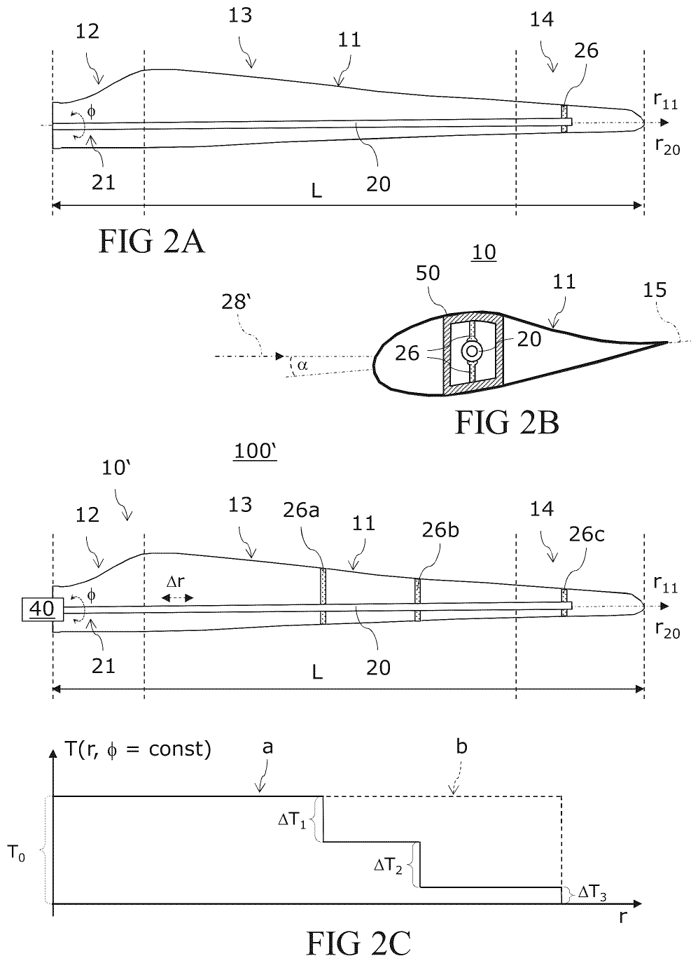

Referring now to FIG. 2A and FIG. 2B, embodiments of a wind turbine blade 10 are explained. Wind turbine blade 10 may be used as rotor blade 108 of wind turbine 100 explained above with respect to FIG. 1.

The exemplary wind turbine blade 10 has an outer shell 11 defining an airfoil.

Wind turbine blade 10 extends in a longitudinal direction r₁₁ from a root portion 12 to a tip portion 14 and has a span width L in direction r₁₁. Root portion 12 and tip portion 14 are connected with each other via a middle portion 13 of shell 11.

An exemplary tubular torque transferring member 20, for example a fiber-reinforced plastic tube, is arranged inside shell 11 so that that its longitudinal axis r₂₀ is at least substantially coaxial to the longitudinal direction r₁₁.

The longitudinal extension of the tubular torque transferring member 20 in the direction of the longitudinal axis r₂₀ and the longitudinal direction r₁₁, respectively, may be about the span width L of rotor blade 10, and as such larger than 10 m or even 50 m.

Typically, the longitudinal extension of the tubular torque transferring member 20 is smaller the span width L, for example in a range from about 30% to about 99%, more typically in a range from about 60% to about 80%, but may also be larger than the span width L, if the torque transferring member 20 protrudes the root portion 12.

A root section 21 of torque transferring member 20 is rotatably around the longitudinal axis r₂₀ with respect to the root portion 12 of shell 11.

In the exemplary embodiment, the torque transferring member 20 is mechanically connected via a coupling 26 with tip portion 14 of shell 11 for providing a torsional moment (for substantially influencing the torsion of wind turbine blade 10 during operating of a wind turbine).

As illustrated in FIG. 2A, this may be achieved by adjusting an angle φ of rotation of the root section 21 of the torque transferring member 20 around the longitudinal axis r₂₀.

Accordingly, the twisting state of rotor blade 10 may be changed as desired for the current operating conditions of a wind turbine provided with one or more rotor blades 10.

For example, the tip portion 14 may, e.g. at higher wind speeds, be twisted out of the wind to reduce noise without reducing the energy capture too much.

As illustrated in FIG. 2B, coupling 26 may be arranged between torque transferring member 20 and a main load bearing structure of wind turbine blade 10. In the exemplary embodiment, the main load bearing structure is implemented as a spar 50 attached to shell 11.

Note that rotor blade 10 is typically fabricated by securing various “shell” and/or “rib” portions to one or more “spar” members extending spanwise along the inside of the blade for carrying most of the weight and aerodynamic forces on the blade. Spars are typically configured as I-shaped beams having a web, referred to as a “shear web,” extending between two flanges, referred to as “caps” or “spar caps,” that are secured to the inside of the suction and pressure surfaces of the blade. However, other spar configurations may also be used including, but not limited to “C-,” “D-,” “L-,” “T-,” “X-,” “K-,” and/or box-shaped beams as illustrated in FIG. 2B. The shear web may also be utilized without caps.

“Angle of attack” is a term that is used in to describe the angle a between the chord line 15 of the blade 10 and the vector 28′representing the relative motion between the blade and the air. “Pitching” refers to rotating the angle of attack of the entire blade 10 along the spanwise axis and longitudinal direction r₁₁, respectively, into or out of the wind in order to control the rotational speed and/or absorption of power from the wind. For example, pitching the blade “towards feather” rotates of the leading edge of the blade 10 into the wind, while pitching the blades “towards stall” rotates the leading edge of the blade out of the wind.

Since the speed of the blade 10 relative to air increases along the longitudinal direction r₁₁ (span) of the rotating blade, the shape of the blade is typically twisted using torque transferring member 20 and coupling 26 in order to maintain a desired angle of attack at several or even most points along the span of the blade.

FIG. 2C illustrate, in the upper part, a rotor blade 10′ and a wind turbine 100′ according to the present disclosure, and, in the lower part, corresponding exemplary plots of torque T as function of the longitudinal coordinate (span) r measured in direction of longitudinal axis r₂₀ of rotor blade 10′.

Wind turbine 100′ is typically similar to wind turbine 100 explained above with respect to FIG. 1. Likewise, rotor blade 10′ is typically similar to rotor blade 10 explained above with respect to FIGS. 2A, 2B.

However, in the exemplary embodiment of FIG. 2C, an actuator 40 provided by wind turbine 100′ is mechanically connected with root section 21 of torque transferring member 20 of rotor blade 10′.

For example, actuator 40 may be provided by a hub of wind turbine 100′ to which rotor blade 10′ is connected.

Alternatively, actuator 40 may be completely arranged inside rotor blade 10′, for example in root section 21 or even in middle section 13. In these embodiments, actuator 40 may be attached to a main load bearing structure of the wind turbine blade. Further, the longitudinal extension of torque transferring member 20 may be correspondingly smaller.

Furthermore, torque transferring member 20 is mechanically connected via three couplings 26a-26c with blade shell 11 at respective locations which are spaced apart from each other in the longitudinal direction r₁₁.

Actuator 40 is typically firmly connected with root section 21 of torque transferring member 20 and may be used to adjust an angle φ of rotation of root section 21 around the longitudinal axis r₂₀.

Depending on angle φ and the coupling properties of couplings 26a, 26b, 26c (coupling status), torsional moments ΔT₁, ΔT₂ and ΔT₃ may be exerted on shell 11 via the couplings 26a, 26b, 26c.

While in the embodiment represented by curve a, a respective portion ΔT₁, ΔT₂ and ΔT₃ of the total torque T₀ (T₀=ΔT₁+ΔT₂+ΔT₃) is exerted at three different longitudinal coordinates r, the total torque T₀ is only exerted via couplings 26c to tip portion 14 in the embodiment represented by curve b.

Accordingly, the twisting status of rotor blade 10′ may be changed by changing the total torque T₀ (via angle φ) as well as by changing the coupling status of one or more of the couplings.

In one embodiment, the coupling status of one or more of the couplings 26a-c may be changed controllably by moving the torque transferring member 20 with actuator 40 in the longitudinal direction r₁₁, e.g. by retraction and outward pushing as indicated by Δr in FIG. 2C.

For example, only the coupling status of couplings 26a, 26b may be changeable by moving the torque transferring member 20 with actuator 40 in the longitudinal direction r₁₁ (for switching between curves a, b).

Alternatively, the coupling status of the respective coupling may be actively controlled using a corresponding separate actuator.

As the mechanical coupling properties of the couplings are known in advance or are even tunable (for each coupling status), the torsional moments exerted on the shell 11 are known for given total torque T₀.

This information may be used for a feedback control of the twisting status of rotor blade 10′.

In particular, the total torque T₀ may be determined by the actuator 40 which is also used as a torque meter in this embodiment.

More particular, a drive current of a motor used for rotating root section 21 of torque transferring member 20 may be used as measure of total torque T₀.

Alternatively or in addition, one or more separate torque meters may be used.

For example, a respective torque meter may be provided by one or more couplings and/or be arranged next to the respective coupling, e.g. on a lower portion and/or an upper portion of coupling 26 in FIG. 2B.

In the following methods are explained that may be performed by a wind turbine with one or more rotor blades as explained herein and/or controlled by the control system of the wind turbine.

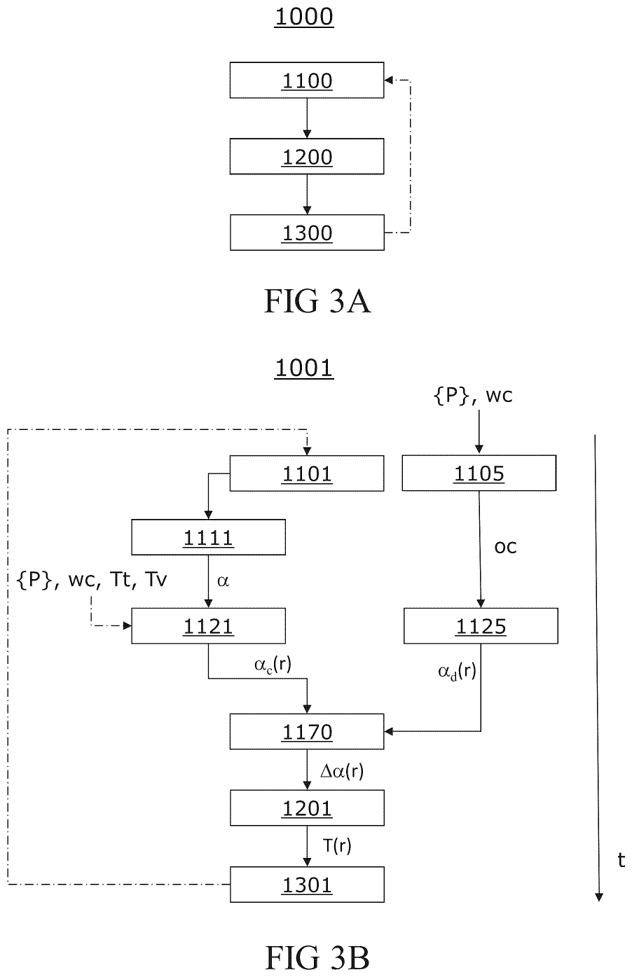

FIG. 3A illustrates a flow chart of a method 1000 for operating a wind turbine having a rotor with one or more rotor blades each comprising a shell extending in a longitudinal direction. A torque member is mechanically connected via at least one coupling with the shell for providing a respective torsional moment on the shell. The rotor blades may in particular be rotor blade 10, 10′ as explained above with regard to FIGS. 2A-2C. An actuator is mechanically connected with the torque (transferring) member.

In a first block 1100, a current torsional state of the shell is determined.

The current torsional state may be determined based on one or more current operating parameters of the wind turbine, in particular a current wind condition.

Determining the current torsional state of the shell may include at least one measurement, for example a measurement of the wind speed in front of the wind turbine and a measurement of the total torque exerted on the shell and the torque member, respectively, using a look-up table, a calculation and/or a simulation.

For example, the current torsional state may be determined from the look-up table using the above mentioned measurements and/or one or more other operational parameters of the wind turbine such as a rotor position and a horizontal misalignment between a rotor axis of the rotor and the wind direction such as an upflow, a yaw misalignment, a shear of the wind and/or a veer as input, and optionally a subsequent interpolation.

Alternatively, a trained neural network may be used to determine the current torsional state.

Thereafter, in a block 1200, a desired torsional state of the shell is determined. The desired torsional state of the shell may in particular be a currently desired torsional state of the shell or a desired torsional state of the shell for the next time window (of a control loop).

Determining the desired torsional state of the shell may also include at least one measurement, using a further look-up table, a further calculation, a further simulation and/or a further trained neural network.

Further, the desired torsional state is typically not only determined as function of the operating parameters such as a rotor position, a wind speed, and/or horizontal misalignment between a rotor axis and the wind direction, but also in accordance with one or more optimizing criteria such as noise production, power production, and a stability criterion.

Note that, in particular for larger rotors, upflow, yaw misalignment, shear and veer make may result in high angle of attack induced stall in one region and low angle of attack stall in another of the rotor blades. This may be avoided by changing the twisting status of the wind turbine blade(s) as explained herein.

Thereafter, in a block 1300, the actuator and/or the coupling(s) are used to change the torsional moment(s) acting on the shell next to the coupling(s) (coupling point(s)) so that a difference between the current torsional state of the shell and the desired torsional state of the shell is expected to be at least reduced, typically expected to be minimized.

For this purpose, the actuator may rotate a root section of the torque transferring member.

Alternatively or in addition, a coupling status of the coupling(s), i.e. a state/mechanical property of the coupling between the torque transferring member and the coupling such as a stiffness, a clearance or an engagement, may be changed.

Accordingly, changing the torsional moment(s) acting on the shell typically includes determining (and applying) appropriate drive parameter(s) for the actuator and/or the coupling(s).

The drive parameter(s) may e.g. be determined from yet another look-up table or using yet another trained neural network.

It is even conceivable that the drive parameter(s) are directly determined as outputs of a single trained neural network which only implicitly determines the current torsional state and the desired torsional state, e.g. in hidden layers, when one or more operating parameters and one or more optimizing criteria are received as input.

The torsional state of the shell may in particular be changed to counter act an instability of the wind turbine blade such as a whirling instability, to adjust a distribution of an angle of attack over the length of the wind turbine blade, to aid in pitching the wind turbine blade, to reduce noise, and/or to align the aerodynamic and/or mechanic properties of the wind turbine blade with another wind turbine blade of the wind turbine.

As indicated by the dashed-dotted arrow in FIG. 3A, method 1000 may be performed several times (in loops).

Depending on the optimizing criterion, the cycle time for one loop of method 1000 may vary.

For example, for counter-acting forward- an/or backward whirling instabilities, the cycle time may be below a second, for example about 0.5 s, while optimizing the power production may only be performed once a minute or the like.

FIG. 3B illustrates a flow chart of a method 1001 for operating a wind turbine. Method 1001 is typically similar to method 1000 explained above with respect to FIG. 6A but more detailed.

In a block 1101, the current torsional state of the shell of a rotor blade is determined as function of the longitudinal coordinate (spatial coordinate with respect to longitudinal direction and axis, respectively, of the shell).

In a subsequent block 1111, a parameter, in particular an angle of attack a may be selected for the rotor blade.

In a subsequent block 1121, a current functional dependency of the selected parameter α_{c}(r) in the longitudinal direction may be determined.

In a block 1105, one or more optimizing criteria oc may be selected for the rotor blade.

Selecting the optimizing criterion (criteria) typically depends on one or more current operating parameters {P} of the wind turbine and/or a current wind condition wc, in particular a wind speed.

The optimizing criterion is typically selected from a noise, a load, a power production, a stability, and any combination thereof.

For example, the optimizing criterion may refer at low wind speed to noise and power production, at medium wind speed to noise and loads, and at high wind speed with respect to noise and stability.

Accordingly, the optimizing criterion may be selected depending on the wind speed and a threshold value(s) for the wind speed.

Block 1105 may be performed at the same time t as block 1101 but also later or prior to block 1101.

Block 1105 may even be entered less frequent compared to block 1101 when method 1001 is performed several times as indicated by the dashed-dotted arrow.

In a block 1125 subsequent to block 1125, a desired functional dependency α_{d}(r) of the selected at least one parameter a in the longitudinal direction may be determined in accordance with the selected optimizing criterion oc.

In a block 1120, a deviation Δα(r) between the current functional dependency and the desired functional dependency of the selected at least one parameter α is determined.

Thereafter, a desired torsional moment T(r) to be exerted on the shell in order to at least reduce, typically minimize the deviation Δα(r) is determined.

Thereafter, the actuator and/or the couplings may be used to change the torsional moment acting on the shell accordingly, in a block 1301.

The technology described above offers various advantages over conventional approaches. It allows the rotor blades to be efficiently torsionally deformed so that a twisting state of the rotor blade is, depending on one or more operating parameters and one or more optimizing criteria, closer to a respective optimum twisting state of the rotor blade. In particular, a desired (optimum) angle of attack over the rotor blade length may be achieved at a wider range of operating parameter(s). Energy capture can therefore be enhanced at low extra costs.

Exemplary embodiments of rotor blades and methods for operating wind farms are described above in detail. The systems and methods are not limited to the specific embodiments described herein, but rather, components of the systems and/or steps of the methods may be utilized independently and separately from other components and/or steps described herein.

Although specific features of various embodiments of the invention may be shown in some drawings and not in others, this is for convenience only. In accordance with the principles of the invention, any feature of a drawing may be referenced and/or claimed in combination with any feature of any other drawing.

Embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a non-transitory computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

This written description uses examples to disclose the invention, including the best mode, and also to enable any person skilled in the art to practice the invention, including making and using any devices or systems and performing any incorporated methods. While various specific embodiments have been disclosed in the foregoing, those skilled in the art will recognize that the spirit and scope of the claims allows for equally effective modifications. Especially, mutually non-exclusive features of the embodiments described above may be combined with each other. The patentable scope of the invention is defined by the claims, and may include other examples that occur to those skilled in the art. For example, the control system of the wind farm may be provided by one centralized controller or a plurality of interconnected controllers. Such other examples are intended to be within the scope of the claims if they have structural elements that do not differ from the literal language of the claims, or if they include equivalent structural elements with insubstantial differences from the literal language of the claims.

### REFERENCE NUMBERS

rotor blades 10, 10′, 108
rotor blade shell 11
root portion of blade shell 12
middle portion of blade shell 13
tip portion of blade shell 14
torque transferring member 20
root section 21
coupling 26-26c
rotor axis 30
spar 50
actuator 40
wind turbine 100, 100′
nacelle 102
tower 104
yaw system 105
rotor 106
meteorological mast 107
pitch system 109
hub 110
method, method steps 1000-1301

1-15. (canceled)

16. A wind turbine blade, comprising:
a shell comprising a root portion, the shell extending in a longitudinal direction; and
a torque transferring member at least partly arranged inside the shell;
the torque transferring member comprising a root section and a longitudinal axis oriented along the longitudinal direction of the shell, the root section rotatable around the longitudinal axis relative to the root portion and mechanically connected via at least one coupling with the shell to provide a torsional moment on the shell.

17. The wind turbine blade of claim 16, wherein the torsional moment on the shell is established by one or both of an angle of rotation of the root section of the torque transferring member around the longitudinal axis and a coupling status between the torque transferring member and the coupling.

18. The wind turbine blade of claim 17, wherein the coupling is controllable to change the coupling status is controllable, and further comprising a torque meter configured to measure a torque value acting at the torque transferring member.

19. The wind turbine blade of claim 16, wherein the torque transferring member is mechanically connected via a plurality of the couplings with the shell at spaced apart locations along the longitudinal direction, the couplings each arranged between a load bearing structure of the wind turbine blade and the torque transferring member.

20. The wind turbine blade of claim 19, wherein mechanical properties of at least two of the couplings are different, the mechanical properties of each of the couplings based on one or more of: a direction or magnitude of an angle of rotation of the torque transferring member, and wherein one or both of a clearance and a stiffness between the couplings and a connected portion of the torque transferring member is changeable.

21. The wind turbine blade of claim 16, wherein the torque transferring member comprises one or a combination of: a cylindrical outer surface, a cylindrical shell, a tube, and a fiber-reinforced plastic.

22. A method for operating a wind turbine having a rotor with the wind turbine blade according to claim 16 and an actuator mechanically connected with the torque transferring member, the method comprising:
determining, during operating the wind turbine, a current torsional state of the shell;
determining a desired torsional state of the shell; and
using the actuator and the coupling to change the torsional moment on the shell so that a difference between the current torsional state of the shell and the desired torsional state of the shell is reduced.

23. The method of claim 22, wherein:
at least one of the current torsional state and the desired torsional state of the shell are determined based on one or more current operating parameters of the wind turbine;
determining the current torsional state of the shell comprises at least one of a measurement, using a look-up table, a calculation, or a simulation; and
the desired torsional state of the shell is determined and the torsional moment on the shell is changed as a function of at least one of: position of the rotor, a wind speed, a horizontal misalignment between a rotor axis of the rotor and a wind direction.

24. The method of claim 22, wherein the torsional state of the shell is changed for one or a combination of:
to counteract an instability of the wind turbine blade;
to adjust a distribution of an angle of attack over a of the wind turbine blade;
to aid in pitching the wind turbine blade;
to reduce noise; and
to align the aerodynamic or mechanical properties of the wind turbine blade with another wind turbine blade of the wind turbine.

25. The method of claim 22, further comprising one or a combination of:
determining the current torsional state of the shell as a function of a longitudinal coordinate with respect to the longitudinal direction of the shell;
selecting a parameter for the wind turbine blade, and determining a current functional dependency of the parameter in the longitudinal direction of the shell, and determining a deviation between the current functional dependency and a desired functional dependency of the selected parameter in the longitudinal direction of the shell;
determining one of a desired twist of the shell or a desired torsional moment to be exerted on the shell in order to reduce the deviation; and
selecting an optimizing criterion that depends on a current operating parameter of the wind turbine or a current wind condition, and determining a desired functional dependency of the selected optimizing criterion in the longitudinal direction of the shell.

26. A wind turbine, the wind turbine comprising the wind turbine of claim 16.

27. The wind turbine of claim 26, further comprising an actuator connected with the root section of the torque transferring member and configured to rotate the root section around the longitudinal axis of the torque transferring member.

28. The wind turbine of claim 27, wherein the actuator is configured to move the root section in the longitudinal direction of the shell and to measure a total torque applied by the torque transferring member.

29. The wind turbine of claim 28, further comprising a controller connected with the actuator and configured to control the actuator based on the measured torque.

30. The wind turbine of claim 29, wherein the controller is configured to operate the wind turbine in accordance with the method of claim 22.
